(19) United States
(12) Patent Application Publication
(10) Pub. No.: US 2007/0131183 A1
(43) Pub. Date: Jun. 14, 2007

(54) Multi-stage variable displacement engine

(75) Inventor: Tsung-Wei Shei, Zhubei City (TW)

Correspondence Address: BRUCE H. TROXELL, SUITE 1404, 5205 LEESBURG PIKE, FALLS CHURCH, VA, 22041, US

(73) Assignee: INDUSTRIAL TECHNOLOGY RESEARCH INSTITUTE

(21) Appl. No.: 11/432,537

(22) Filed: May 12, 2006

(30) Foreign Application Priority Data
Dec. 13, 2005 (TW) 094144021

(51) Int. Cl. F02B 75/04; F02B 75/22; F02B 75/20; F02F 1/00; F02F 11/00

(52) U.S. Cl. 123/48 R; 123/193.2; 123/193.3; 123/54.4; 123/58.1

(57) ABSTRACT

The present invention relates to an uneven cylinder displacement arrangement of a multi-stage variable displacement engine. By arranging a plurality of cylinders of at least two different cylinder bores or at least two different strokes in an engine while grouping the plural cylinders into at least two cylinder groups, e.g. grouping odd-numbered cylinders in an ignition sequence of the engine into a first group while grouping even-numbered cylinders in an ignition sequence of the engine into a second group, the engine is enabled to have multi-stage displacement capability adapted to various operation speeds for reducing fuel consumption since the displacement of the engine can be varied by using the ignition sequence to control and select which groups are to be ignited for matching the current load of the engine. In a preferred embodiment of the invention, there are two kinds of cylinders of different cylinder bores arranged in an engine which are grouped into two cylinder groups by the control of the ignition sequence of the engine, whereas the cylinder bore of a cylinder grouped in one of the two cylinder group is the same as another cylinder of the same cylinder group, but is different to those grouped in another cylinder group.

### FIELD OF THE INVENTION

The present invention relates to a multi-stage variable displacement engine, and more particularly, to an engine with uneven cylinder displacement arrangement for enabling the engine to have multi-stage displacement capability adapted to various vehicle driving conditions so as to optimize the efficiency of the powertrain and thus reduce fuel consumption.

### BACKGROUND OF THE INVENTION

Most common automobile internal-combustion engines are operated with better fuel consumption as they are subjected to a high-load condition while engine is running around at the speed from 2000 rpm to 3500 rpm, i.e. the fuel saving zone of an engine commonly falls in those running conditions. However, when an automobile is running in an urban area as it does most of the time, its engine is subjected to a partial-load condition that the engine is not operated in the fuel saving zone. Conventionally, to improve the fuel economy of automobile, a valve actuation control technology is applied to an engine for adapting the displacement of the engine flexibly to different vehicle driving conditions, such that only a half cylinders of the engine are activated to operate when the engine is subjected to lower loading conditions, and thereby not only the pumping loss of engine can be reduced, but also the engine may have more chance to run in its fuel saving zone. The valve actuation mechanism is capable of enabling the engine to keep both intake and exhaust valves of the specific cylinders closing as the engine is subjecting to certain running conditions, i.e. the engine is enabled to operated under half-displacement mode, and to reactivate those closed valves for recovering the engine to its full-displacement mode as the engine is subjecting to a high-load condition. Generally, to maintain engine to run smoothly, usually half cylinders of an engine are designed to be inactive as the engine is subjecting to certain running conditions. For example, only four cylinders in an eight-cylinder engine are deactivated as the engine is subjecting to a low-load condition, and three cylinders in a six-cylinder engine are deactivated as the engine is subjecting to a low-load condition. However, since the displacements of individual cylinder of each aforesaid conventional engine are all the same as each other, those conventional engines are only capable of switching between two mode of displacements, i.e. each can only be switching between full displacement and half displacement. As an inline multi-cylinder engine 10 shown in FIG. 1, all of the four cylinders 11a˜d of the inline engine 10 are activated to operate for enabling a full displacement operation, or only the two cylinders 11c, 11d are activated to operate for enabling a half displacement operation. That is, the engine 10 can be controlled to activate all the cylinders 11a˜d to run at full displacement or to activate two cylinders 11a, 11b and deactivate the other two cylinders 11c, 11d to run at half displacement. In addition, as a V-type or a horizontally-opposed multi-cylinder engine 20 shown in FIG. 2, all of the cylinders 21a˜f of the V-type engine 20 are activated to operate for enabling a full displacement operation, or only the three cylinders 21a˜c are activated to operate for enabling a half displacement operation. That is, the engine 20 can be controlled to activate all the cylinders 21a˜f to run at full displacement or to deactivate three cylinders 21a˜c and activate the other three cylinders 21d˜f to run at half displacement. As there are more modes of displacement can be controlled, the engine can have more chances to run at its fuel saving zone. Therefore, it is desired to increase the variety of displacement for further facilitating the engine to work in its fuel saving zone and thereby further improving fuel economy of automobiles.

### SUMMARY OF THE INVENTION

In view of the disadvantages of prior art, the primary object of the present invention is to provide a multi-stage variable displacement engine with uneven cylinder displacement arrangement for enabling the engine to have multi-stage displacement capability adapted to various vehicle driving conditions so as to optimize the efficiency of the powertrain and thus reduce fuel consumption.

To achieve the above object, the present invention provides a multi-stage variable displacement engine, which comprises an engine block having a plurality of cylinders of at least two different displacements.

Preferably, the engine block is comprised of the plural cylinders of at least two different cylinder bores.

Preferably, the engine block is comprised of the plural cylinders of at least two different cylinder strokes.

Preferably, the engine block is comprised of the plural cylinders of at least two different cylinder bores and at least two different strokes.

Preferably, the plural cylinders can be grouped into at least two cylinder groups, whereas the total displacements of different cylinder groups are different from each other.

Preferably, the odd-numbered cylinders in an ignition sequence of the engine block is grouped into a first group while the even-numbered cylinders in the ignition sequence of the engine block is grouped into a second group.

Preferably, different cylinder groups can have different amount of cylinders.

Preferably, the cylinders grouped into the same cylinder group can have different cylinder bores.

Preferably, the cylinders grouped into the same cylinder group can have different stokes.

Preferably, the engine can be an inline multi-cylinder engine, a V-type or horizontally-opposed multi-cylinder engine.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a schematic view of a cylinder configuration of a conventional inline multi-cylinder engine.

FIG. 2 is a schematic view of a cylinder configuration of a conventional V-type or horizontally-opposed multi-cylinder engine.

FIG. 3 is a schematic diagram illustrating the application of a cylinder configuration of the present invention upon an inline multi-cylinder engine according to a preferred embodiment of the present invention.

FIG. 4 is a schematic is a schematic diagram illustrating the application of a cylinder configuration of the present invention upon a V-shaped or horizontally-opposed multi-cylinder engine according to a preferred embodiment of the present invention.

FIG. 5 is a schematic diagram illustrating the application of a cylinder configuration of the present invention upon an inline multi-cylinder engine according to another preferred embodiment of the present invention.

FIG. 6 is a schematic is a schematic diagram illustrating the application of a cylinder configuration of the present invention upon a V-shaped or horizontally-opposed multi-cylinder engine according to another preferred embodiment of the present invention.

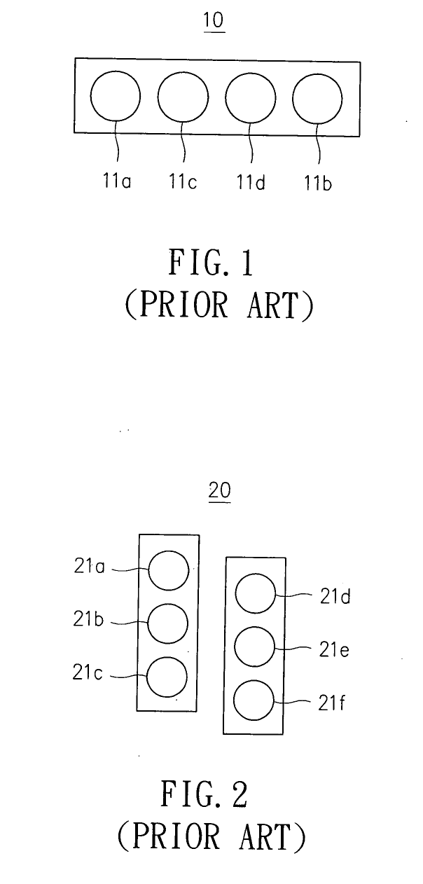

### DESCRIPTION OF THE PREFERRED EMBODIMENTS

For your esteemed members of reviewing committee to further understand and recognize the fulfilled functions and structural characteristics of the invention, several preferable embodiments cooperating with detailed description are presented as the follows.

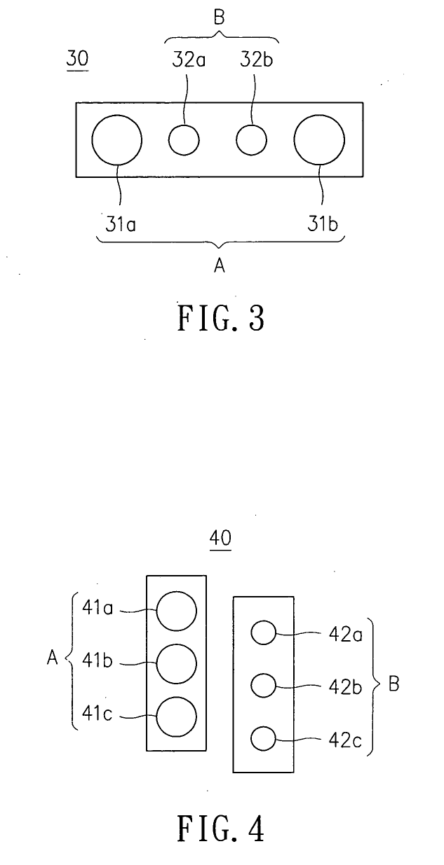

Please refer to FIG. 3, which is a schematic diagram illustrating the application of a cylinder configuration of the present invention upon an inline multi-cylinder engine according to a preferred embodiment of the present invention. The inline multi-cylinder engine 30 has four cylinders 31a, 31b, 32a, 32b. The cylinders 31a, 31b, being the odd-numbered cylinders with respect to a specific ignition sequence, are grouped into group A. The cylinders 32a, 32b, being the even-numbered cylinders with respect to the specific ignition sequence, are grouped into group B. The cylinder bores of the two odd-numbered cylinders 31a, 31b of group A are the same, and the cylinder bores of the two even-numbered cylinders 32a, 32b of group B are the same, whereas the diameter of the cylinders 32a, 32b of group B is smaller than that of the cylinders 31a, 31b of group A. That is, the displacement of each cylinder 32a, 32b of group B is smaller than that of each cylinder 31a, 31b of group A. A valve mechanism (not shown) can be controlled to enable the inline multi-cylinder engine 30 to run only with the cylinders 31a, 31b of group A or only with the cylinders 32a, 32b of group B, or with all the cylinders 31a, 31b, 32a, 32b. Thus, the inline multi-cylinder engine 30 has three operation modes with different displacement. The total displacement is least when only the cylinders 32a, 32b of group B are enabled to operate. The total displacement is larger when only the cylinders 31a, 31b of group A are enabled to operate. The total displacement is largest when all the cylinders 31a, 31b, 32a, 32b are enabled to operate.

Please refer to FIG. 4, which is a schematic is a schematic diagram illustrating the application of a cylinder configuration of the present invention upon a V-shaped or horizontally-opposed multi-cylinder engine according to a preferred embodiment of the present invention. The V-shaped or horizontally-opposed multi-cylinder engine 40 has six cylinders 41a˜c, 42a˜c. The cylinders 41a˜c, being the odd-numbered cylinders with respect to a specific ignition sequence, are grouped into group A. The cylinders 42a˜c, being the even-numbered cylinders with respect to the specific ignition sequence, are grouped into group B. The cylinder bores of the odd-numbered cylinders 41a˜c of group A are the same, and the cylinder bores of the even-numbered cylinders 42a˜c of group B are the same, whereas the diameter of the cylinders 432a˜c of group B is smaller than that of the cylinders 41a˜c of group A. That is, the displacement of each cylinder 42a˜c of group B is smaller than that of each cylinder 41a˜c of group A. A valve mechanism (not shown) can be controlled to enable the V-shaped or horizontally-opposed multi-cylinder engine 40 to run only with the cylinders 41a˜c of group A or only with the cylinders 42a˜c of group B, or with all the cylinders 41a˜c, 42a˜c. Thus, the V-shaped or horizontally-opposed multi-cylinder engine 40 has three operation modes with different displacement. The total displacement is least when only the cylinders 42a˜c of group B are enabled to operate. The total displacement is larger when only the cylinders 41a˜c of group A are enabled to operate. The total displacement is largest when all the cylinders 41a˜c, 42a˜c are enabled to operate.

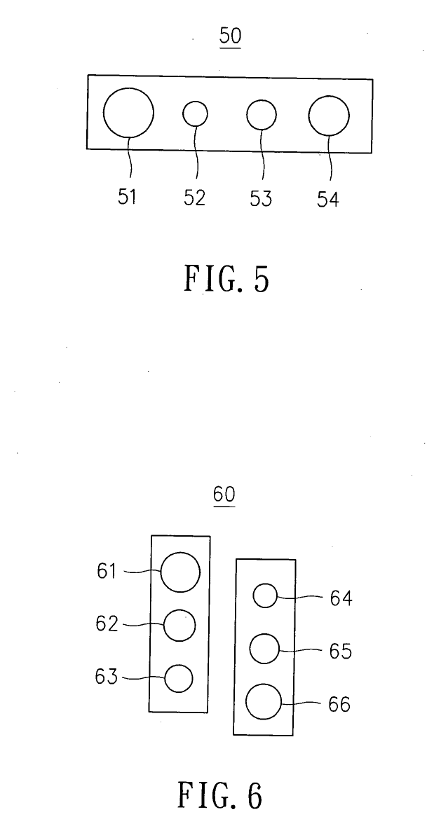

The embodiments shown in FIGS. 3 and 4 are characterized in that the cylinders are configured as two groups of different cylinder bores, thereby enabling the engine to have three displacements. Similarly, when the cylinder bores of the cylinders are different from each other, the engine may be designed with more displacement variation. As shown in FIG. 5, an inline multi-cylinder engine 50 has four cylinders 51, 52, 53, 54 with different cylinder bore. Ideally, each of the four cylinders 51, 52, 53, 54 can be enabled to operate separately, or can be enabled to operate in grouping. For instance, the cylinder 51 and the cylinder 52 are enabled to operate while the cylinder 53 and the cylinder 54 are disabled, or the cylinder 52 and the cylinder 53 are enabled to operate while the cylinder 51 and the cylinder 54 are disabled, or the cylinder 51, the cylinder 52 and the cylinder 53 are enabled to operate while the cylinder 54 is disabled, or all four cylinders 51, 52, 53 are enabled to operate together. Thus, the inline multi-cylinder engine 50 has fourteen operation modes with different displacement. Similarly, as shown in FIG. 6, a V-shaped or horizontally-opposed multi-cylinder engine 60 has six cylinders 61˜66 with different cylinder bores. The cylinders may be arranged in pairs or groups to work, thereby enabling the V-shaped or horizontally-opposed multi-cylinder engine 60 to have displacement variation.

The cylinders configured with different cylinder bores are described in the above embodiments. It is noted that the stroke of those cylinders are maintained to be the same so as to enable the connecting surface of cylinder bore and the cylinder head of each cylinder to be maintained at the same level. However, the stroke of each cylinder may be different. The cylinders with different cylinder bores and different strokes may be arranged in pairs or groups to form a multi-stage variable displacement engine. In addition, it must be noted that problems of engine balance, noise and vibration due to different cylinder bore, different cylinder stroke or disabled cylinder may be overcome through conventional technique and do not adversely affect the fuel efficiency of the present invention.

As described above, the multi-stage variable displacement engine of the present invention is to configure at least two kinds of cylinders with different displacement in the engine whereby the cylinders with different diameters and/or different strokes are arranged in at least two groups for enabling the engine to have multiple displacement capability fitted to different vehicle operating conditions, thereby the fuel efficiency of the engine is improved.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A multi-stage variable displacement engine, comprising an engine block having a plurality of cylinders of at least two different displacements and at least two different cylinder bores.

2. The multi-stage variable displacement engine of claim 1, wherein the plural cylinders can be grouped into at least two cylinder groups as the total displacements of different cylinder groups are different from each other.

3. The multi-stage variable displacement engine of claim 2, wherein the odd-numbered cylinders in an ignition sequence of the engine block is grouped into a first group while the even-numbered cylinders in the ignition sequence of the engine block is grouped into a second group.

4. The multi-stage variable displacement engine of claim 2, wherein different cylinder groups can have different amount of cylinders.

5. The multi-stage variable displacement engine of claim 2, wherein the cylinders grouped into the same cylinder group can have different cylinder bores.

6. The multi-stage variable displacement engine of claim 2, wherein the cylinders grouped into the same cylinder group can have different stokes.

7. The multi-stage variable displacement engine of claim 1, wherein the engine block is comprised of the plural cylinders of at least two different strokes.

8. The multi-stage variable displacement engine of claim 7, wherein the plural cylinders can be grouped into at least two cylinder groups as the total displacements of different cylinder groups are different from each other.

9. The multi-stage variable displacement engine of claim 8, wherein the odd-numbered cylinders in an ignition sequence of the engine block is grouped into a first group while the even-numbered cylinders in the ignition sequence of the engine block is grouped into a second group.

10. The multi-stage variable displacement engine of claim 8, wherein different cylinder groups can have different amount of cylinders.

11. The multi-stage variable displacement engine of claim 8, wherein the cylinders grouped into the same cylinder group can have different cylinder bores.

12. The multi-stage variable displacement engine of claim 8, wherein the cylinders grouped into the same cylinder group can have different stokes.

13. The multi-stage variable displacement engine of claim 1, wherein the engine block is comprised of the plural cylinders of at least two different cylinder bores and at least two different strokes.

14. The multi-stage variable displacement engine of claim 13, wherein the plural cylinders can be grouped into at least two cylinder groups as the total displacements of different cylinder groups are different from each other.

15. The multi-stage variable displacement engine of claim 14, wherein the odd-numbered cylinders in an ignition sequence of the engine block is grouped into a first group while the even-numbered cylinders in the ignition sequence of the engine block is grouped into a second group.

16. The multi-stage variable displacement engine of claim 14, wherein different cylinder groups can have different amount of cylinders.

17. The multi-stage variable displacement engine of claim 14, wherein the cylinders grouped into the same cylinder group can have different cylinder bores.

18. The multi-stage variable displacement engine of claim 14, wherein the cylinders grouped into the same cylinder group can have different stokes.

19. The multi-stage variable displacement engine of claim 1, wherein the engine is an engine selected from the group consisting of an inline multi-cylinder engine, a V-type multi-cylinder engine, and a horizontally-opposed multi-cylinder engine.
